(19) United States
(12) Patent Application Publication
(10) Pub. No.: US 2025/0313501 A1
(43) Pub. Date: Oct. 9, 2025

(54) WASTEWATER TREATMENT METHOD WITH MAXIMIZATION OF BIOGAS PRODUCTION COMPRISING AN ELECTRO-OXIDATION STEP

(71) Applicant: SUEZ INTERNATIONAL, Paris (FR)

(72) Inventors: Mathieu HADDAD, Sevres (FR); Romain MAILLER, Conflans St Honorine (FR); Sofiane MAZEGHRANE, Sartrouville (FR); Clement ROCHE, Saint Etienne (FR)

(73) Assignee: SUEZ INTERNATIONAL, Paris (FR)

(21) Appl. No.: 18/867,019

(22) PCT Filed: May 17, 2023
(86) PCT No.: PCT/FR2023/050707

§ 371 Date: Nov. 19, 2024

(30) Foreign Application Priority Data
May 19, 2022 (FR) 2204775

(51) Int. Cl. C02F 3/30; C02F 3/00; C02F 101/16

(52) U.S. Cl. CPC C02F 3/305; C02F 3/005; C02F 2101/16; C02F 2301/046

(57) ABSTRACT

The invention relates to a method and a plant for treating wastewater and associated sludge that makes it possible to eliminate the carbon and nitrogen with maximization of biogas production. The method comprises: (a) a step of treating wastewater producing a first effluent (2) having a reduced content of carbonaceous material and a second effluent (3) having an increased content of carbonaceous material, (b) a step of treating at least one portion of the first effluent producing a third effluent (4) having a reduced nitrogen content, carried out without use of a biological nitrification under aerobic conditions and comprising of at least one step electro-oxidation during which at least one portion of the ammonium ions contained in the first effluent are oxidized to nitrites and/or nitrates, and/or to dinitrogen, (c) a step of anaerobic digestion of the second effluent to produce biogas (7) and a digestate (8).

### BACKGROUND OF THE INVENTION

### 1. Field of the Invention

The invention relates to a method for treating wastewater and associated sludge, in particular a carbon and nitrogen removal process with maximized biogas production.

### 2. Description of the Prior Art

In general, wastewater treatment is a three-step process: A primary treatment step, a secondary treatment step and a tertiary treatment step.

The first step, primary treatment, generally reduces the solids and/or organic matter content of the wastewater to be treated. This typically involves a settling step, possibly assisted by the prior addition of coagulant and flocculant, during which the wastewater is placed in a holding tank or settling basin. The solids contained in the wastewater settle to the bottom of the tank where they are collected, while lighter substances such as fats and oils are collected on top of the wastewater in the tank. This step thus produces so-called primary sludge and an effluent with a reduced solids content. These primary sludges are generally treated by anaerobic digestion to produce biogas, an energy gas composed essentially of methane and carbon dioxide.

The step of secondary treatment reduces the carbon and/or nitrogen and/or phosphorus content of the effluent with reduced solids content exiting the first treatment step. During this step, organic matter, nitrogen compounds and/or phosphorus compounds are assimilated or decomposed by aerobic and/or anaerobic and/or anoxic bacteria. This is a biological treatment step, most often implemented in free-culture reactors (the so-called “activated sludge” process).

The third step, tertiary treatment, is designed to further clean the water when it is discharged into a sensitive ecosystem or for reuse. This step may involve phosphorus and/or micropollutant removal and/or disinfection and/or filtration.

The most common biological process used in the secondary treatment step to remove nitrogen compounds from m wastewater generally involves nitrification followed by denitrification (N/DN), that is, the conversion of ammonia to nitrogen.

Nitrification is an aerobic oxidation reaction, requiring active aeration, wherein a specialized group of autotrophic bacteria oxidizes ammoniacal or ammonium nitrogen, denoted NH₄ or NH₄⁺, to:
nitrous nitrogen, also known as nitrite, NO₂ or NO₂,
then nitrate nitrogen, also known as nitrate, NO₃ or NO₃.

Denitrification is an anoxic reduction process in which a specialized group of heterotrophic bacteria (which may be anaerobic) combine the oxidation of organic substrates with the reduction of nitrates to either nitrous oxide (N₂O) or nitrogen gas (dinitrogen, N₂).

At the end of the nitrification/denitrification step, the nitrogen content must comply with regulatory limits, which can have a significant impact on the design of the treatment to be carried out. Typically, the lower the nitrogen limit, the longer the nitrification step and the greater the aeration required (high oxygen demand). Moreover, low nitrogen levels are difficult to achieve by biological denitrification treatment, which also requires large quantities of biodegradable carbon, often supplied externally, when the biodegradable carbon is not available in sufficient quantities in the effluent to be treated relative to the quantity of oxidized nitrogen to be denitrified.

Sludge retention time (SRT) is one of the key parameters for treatment plant design, as autotrophic nitrifying bacteria have a lower growth rate than heterotrophic denitrifying microorganisms, and must be maintained in the system to achieve effective nitrification. This growth rate also decreases with operating temperature. Thus, low temperatures and/or low nitrogen discharge limits require prolonged aeration, as well as an increase in the age of the sludge produced, sludge retention time, and hydraulic retention time, all of which affect the sizing of the units. While a long sludge retention time allows autotrophic nitrifying bacteria to develop properly, the quantity of biomass formed under these conditions is reduced; the system is said to be operating under low load. On the other hand, a short sludge retention time limits or even prevents the development of nitrifying bacteria, and consequently denitrification, but increases the quantity of biomass formed; the system is said to be operating under high load.

However, the methanogenic potential of aeration sludge from nitrification treatment in prolonged aeration (“low-load” operation) is lower than that of sludge in “high-load” operation, which translates into lower anaerobic digestion performance during subsequent treatment, and therefore lowers biogas production. For example, it is necessary to work with “young” sludge to achieve a higher methanogenic potential and increase biogas production, but, under these conditions, nitrogen treatment is weak or non-existent.

Strict nitrogen discharge limits result not only in high construction costs due to high sludge retention times and hydraulic retention times, but also in high operating costs due in particular to the addition of reagents (adding carbonates to increase alkalinity during autotrophic nitrification, adding methanol as an external carbon source during heterotrophic denitrification, adding a phosphate source in case of nutrient deficiency), high oxygen demand (high aeration) and high pumping flows (internal and external recirculation).

As the wastewater industry moves towards resource recovery and carbon reorientation, maximizing biogas energy recovery becomes essential to improving the energy balance of wastewater treatment plants. However, current design the paradigm for the nitrification/denitrification step of the wastewater treatment process seems incompatible with increasingly stringent nitrogen discharge limit regulations and with the objective of maximizing energy recovery through biogas production. Indeed, to achieve low nitrogen discharge limits, sufficient carbon must be left at the outlet of the primary treatment in order to achieve sufficient denitrification during secondary treatment, which limits the possibility of capturing carbon in the sludge from primary treatment for biogas production.

In particular, for a primary treatment step with a given carbon capture performance, a downstream secondary treatment producing activated sludge under low load has a lower methanogenic potential than a downstream secondary treatment producing activated sludge under high load (also known as “High Rate Activated Sludge” or “HRAS”), wherein the carbon is not treated by a reactor performing biological nitrification. In fact, at low loads, for a long-aged sludge, heterotrophic bacteria do not have enough food, so they consume from their reserves (endogenous respiration), which reduces the methanogenic potential. Conversely, at high loads, there is no nitrification, and therefore no need to work with a long-aged sludge; the sludge produced is therefore younger, and sludge production is higher, as is its methanogenic potential.

The limited recovery of carbon at the end of primary treatment and the lower methanogenic potential of sludge from nitrification in secondary treatment mean that it is not possible to maximize energy recovery through biogas production while reducing the nitrogen content at the end of secondary treatment.

Lastly, current treatments involve numerous intermediate steps to achieve the electron transfer that enables nitrogen compounds to be reduced to dinitrogen:
conversion of electricity into blown air (via a booster) for environmental aeration,
transfer of oxygen (20% from air) to the environment (wastewater),
transfer of oxygen from the environment (wastewater) to the bacteria,
oxygen conversion by the bacteria to oxidize ammonium ions into nitrite/nitrate via electron transfer.

At each of these steps, energy is lost during conversion, making the process more energy-intensive than necessary.

Finally, biological nitrogen treatments are complex to control insofar as the performance of these treatments is controlled indirectly: Bacterial activity is typically regulated by the dissolved oxygen content in the medium, itself controlled by an air injection setpoint and consequently the flow rate of the blower. Moreover, these treatments are only effective after a period of bio-mass growth. In addition, during the biological nitrification step at low load, filamentous bacteria may be produced, which can lead to malfunctions (in particular loss of sludge settleability, resulting in the escape of suspended materials from the clarification outlet) due to swelling and foam formation.

There is therefore a need for a wastewater treatment system that maximizes both biogas production during sludge treatment and nitrogen pollution treatment, without adding reagent(s), or with reduced quantities of reagent(s), regardless of the carbon content of the wastewater to be treated (that is, regardless of the C/N ratio). There is also a need for wastewater treatment that is easier to implement and control.

### SUMMARY OF THE INVENTION

A first object of the invention relates to a method for treating wastewater containing nitrogen in the form of ammonium ions and carbonaceous material, said method comprising:
(a) a wastewater treatment step to produce a first effluent with a reduced carbon content and a second effluent with an increased carbon content,
(b) a step for treating at least part of the first effluent to produce a third effluent with a reduced nitrogen content, and,
(c) an anaerobic digestion step for the second effluent to produce biogas and digestate.

According to the invention, step (b) of said method is carried out without implementing biological nitrification under aerobic conditions and comprises at least one electro-oxidation step during which at least some of the ammonium ions contained in the first effluent are oxidized to nitrites and/or nitrates, and/or to dinitrogen.

This particular sequence of steps, and in particular the use of at least one nitrogen removal step by electro-oxidation, means that the treatment method is less complex to implement than biological nitrogen treatment by nitrification/denitrification. Indeed, control of the electro-oxidation step can be carried out directly by controlling the applied current density and the flow rate of the effluent to be treated, and does not require a biomass growth period.

This sequence is also less costly to implement than a biological denitrification treatment method, in that the use of chemicals is reduced and the overall energy demand is lower, since electro-oxidation treatment requires fewer operating hours to achieve total or partial nitrification (reduced hydraulic retention time) and fewer intermediaries for electron transfer, and biogas production is enhanced.

Electro-oxidation is also a treatment with less risk of malfunction than biological nitrification treatment (no risk of malfunction due to filamentous bacteria production, foaming or sludge swelling). Electro-oxidation also makes it possible to achieve very low nitrogen levels in treated water without being limited by an initial carbon content, and reduces the production of nitrous oxide, a reaction intermediate in the biological reactions of ammonia nitrogen oxidation and nitrate reduction, which is a greenhouse gas.

Since the presence of carbon in the first effluent is not necessary for the operation of step (b), wastewater treatment step (a) can be carried out under conditions that maximize the content of carbonaceous material present in the second effluent, thereby optimizing biogas production by anaerobic digestion in step (c).

Advantageously, treatment step (a) may comprise at least one carbonaceous material treatment step selected from a physical treatment step (a1), optionally preceded by a physical/chemical treatment step (a2), and a biological carbonaceous material treatment step (a3, a4).

Physical and/or physical/chemical treatment reduces the content of solids, organic matter liable to flocculate and possibly phosphorus in the wastewater to be treated, thereby reducing the carbon content of the first effluent.

The use of a physical/chemical treatment upstream of a physical treatment increases the speed of treatment, leading to the use of smaller, and therefore less costly, installations.

Advantageously, the physical treatment step can be selected from a settling step, a flotation step and a filtration step, and the physical/chemical treatment step can be selected from a coagulation-flocculation step, a flocculation step alone and an electrocoagulation step followed by flocculation, or a combination of these steps.

Treatment step (a) may comprise at least one biological treatment step (a3) for carbonaceous matter, particularly under conditions unfavorable to nitrification. The aim here is to treat (that is, remove) only the soluble biodegradable carbonaceous matter (that is, non-particulate carbonaceous matter) in the effluent to be treated, in order to produce a first effluent with a reduced carbonaceous matter content and a second effluent with an increased carbonaceous matter content.

Biological treatment of carbonaceous matter can be carried out under anoxic or oxic conditions.

In one embodiment, step (b) may comprise a step of total electro-oxidation of at least some of the ammonium ions to dinitrogen.

In another embodiment, step (b) may comprise a step of partial electro-oxidation (b1) of at least some of the ammonium ions to nitrates and/or nitrites.

Advantageously, at least part of the effluent produced by said partial electro-oxidation step (b1) can be sent to treatment step (a), upstream or in an anoxic biological treatment step (a3) for the carbonaceous material from step (a).

Recirculating part of the partially oxidized effluent in such an anoxic biological treatment step (a3) maximizes denitrification and carbon removal to produce sludge (forming the second effluent) with a high methanogenic potential. In fact, recirculation in the anoxic biological treatment (a3) step (a) enables the carbon present in the wastewater entering the biological treatment step (a3), and possibly the carbon present in the part of the partially oxidized effluent recycled in this step (a3) made biodegradable by the partial electro-oxidation step, to be abated, while providing the oxygen required for this abatement through the nitrates/nitrites produced during the partial electro-oxidation step (b1), thereby reducing the need for aeration of said carbon biological treatment step (a3).

In a variant, step (b) may comprise the partial electro-oxidation step (b1) wherein some of the ammonium ions are oxidized to nitrates and/or nitrites, for example where only half of the ammonium ions are oxidized to nitrates and/or nitrites, followed by a step (b3) of anoxic biological treatment by oxidation of the ammonium ions by autotrophic anaerobic bacteria (Anammox step). The partial electro-oxidation step (b2) is then incomplete.

In the event that the incomplete partial electro-oxidation step (b1) is followed by this Anammox step (b3), at least some of the effluent produced by this step (b3) can be returned to the treatment step (a), upstream or in an anoxic biological treatment step (a3) for the carbonaceous material from step (a).

An advantage of the Anammox step (b3) at the end of the incomplete partial oxidation step (b1) is that it oxidizes the remaining ammonium ions while reducing the amount of energy required compared with a step (b) involving only one or more electro-oxidation steps.

In another variant, the step (b) may comprise the step of partial electro-oxidation (b1) of at least part, preferably all, of the ammonium ions to nitrates and/or nitrites followed by a step of total electro-oxidation (b2) of at least part, preferably all, of the nitrates and/or nitrites to dinitrogen.

In yet another variant, the step (b) may comprise the partial electro-oxidation step (b1) of some of the ammonium ions (e.g. half) into nitrates and/or nitrites, followed by an anoxic biological treatment step by oxidation of the ammonium ions by autotrophic anaerobic bacteria (b3, Anammox step), followed by a step of total electro-oxidation (b2) of at least some, preferably all, of the nitrates and/or nitrites to nitrogen. The total electro-oxidation step (b2) of nitrates and/or nitrites into dinitrogen is designed to complete the removal of total nitrogen and reach the total nitrogen limit specified or regulated by legislation. Preceding this total electro-oxidation step (b2), the Anammox step (b3) is intended to oxidize some of the ammonium ions, thereby reducing the energy consumption required for the total electro-oxidation step (b2) of nitrates and/or nitrites to nitrogen and reducing the overall energy consumption used in step (b) for nitrogen elimination.

Advantageously, during electro-oxidation step (b), (b1) or (b2), the water present in the effluent can be electrolyzed, resulting in the production of dihydrogen at the cathode and dioxygen at the anode. Dihydrogen and/or dioxygen can then be recovered, and dioxygen can optionally be sent to treatment step (a), either upstream or in a biological treatment step (a3) for the carbonaceous material from step (a).

Advantageously, the treatment method may further comprise a step (d) of treating the third effluent produced by treatment step (b) to produce a fourth effluent, this treatment step (d) comprising at least one treatment selected from a treatment for removing suspended materials, a treatment for removing phosphorus compounds, a treatment for removing micropollutants (in particular organic and/or metallic pollutants) and a treatment for removing microorganisms.

The third effluent treatment step (d) is designed to further clean the water so that it meets discharge standards when discharged into a sensitive ecosystem, or for reuse.

Advantageously, the treatment method may further comprise a control step wherein:
(i1) a quantity of nitrogen present in the third effluent or the fourth effluent and in at least one effluent to be extracted chosen from the first effluent, the effluent from the step of partial electro-oxidation of ammonium ions, and the effluent from step (b3) of anoxic biological treatment by oxidation of ammonium ions by autotrophic anaerobic bacteria is determined, then,
(i2) a quantity of the at least one effluent to be extracted is determined in order to achieve a limit nitrogen content in the third or fourth effluent, and said quantity of the at least one effluent to be extracted is extracted and mixed with the third or fourth effluent, and/or
(i3) a quantity of the effluent from the partial electro-oxidation step (b1) of the ammonium ions to be sent to an anoxic biological treatment step (a3) of step (a) is determined, this quantity corresponding to a nitrate and/or nitrite content necessary for an anoxic biological treatment to eliminate carbonaceous matter, and said quantity of this effluent is sent to the anoxic biological treatment step (a3) of step (a).

The purpose of the control step comprising the sequence (i1) (i2) is to reduce the quantities of effluent treated by step (b) while complying with nitrogen discharge standards in the third effluent, thereby reducing plant dimensions and/or treatment costs. The control step comprising the sequence (i1) (i3) optimizes the recirculation of the effluent produced by the partial electro-oxidation step (b1) so as to provide the necessary quantity of nitrates/nitrites for the abatement in step (a3) of the carbon initially contained in the wastewater. In particular, step (i1) may also involve determining the amount of carbonaceous material contained in the wastewater to be treated entering step (a), and in step (i3), the amount of effluent may be determined as a function of its nitrate and/or nitrite content and the carbonaceous material content of the wastewater to be treated. The control step comprising the sequence (i1) (i3) also makes it possible to optimize the amount of nitrogen to be treated by the total electro-oxidation step (b2) by minimizing it. The control step may implement both step sequences (i1) (i2) and (i1) (i3), or only one of them.

Advantageously, the treatment method may further comprise at least one treatment step (e) for at least part of a liquid fraction of the digestate produced by digestion step (c), this treatment step being selected from an electrocoagulation treatment step (e0), an electro-oxidation treatment step (e1) during which at least some of the ammonium ions contained in said liquid fraction are oxidized to nitrites and/or nitrates, and/or to dinitrogen, an anoxic biological treatment step (e2) by oxidation of ammonium ions by autotrophic anaerobic bacteria (Anammox step) and the succession of the two steps (e1) (e2), preceded or not by step (e0).

Advantageously, the electrocoagulation treatment step (e0) may comprise a sub-step of struvite precipitation by electrochemical dissolution of a sacrificial anode comprising magnesium, coupled with a sub-step of separation of the precipitated struvite.

The purpose of this treatment step (e) is to treat the nitrogen contained in the liquid fraction of the digestate produced by the ammonium-rich digestion step (c), thereby enabling the treated liquid fraction to be returned to the main wastewater feed line of the method, in step (a) or upstream of step (a).

Another object of the invention concerns a wastewater treatment plant containing nitrogen in the form of ammonium ions and carbonaceous material, in particular for implementing the method according to the invention. The treatment plant according to the invention comprises:
a first wastewater treatment unit comprising a wastewater feed line, a first discharge line for a first effluent with a reduced carbon content and a second discharge line for a second effluent with an increased carbon content,
a second treatment unit, comprising a feed line connected to the first line of the first treatment unit, a discharge line for a third effluent having a reduced nitrogen content, the second treatment unit comprising at least one electro-oxidation treatment reaction zone and being devoid of an aerobic biological treatment reaction zone,
a third treatment unit employing anaerobic digestion, comprising a feed line connected to the second line of the first treatment unit, a biogas discharge line and a digestate discharge line.

Advantageously, the first unit may comprise at least one reaction zone selected from a physical treatment reaction zone, optionally coupled to a physical/chemical treatment reaction zone, and a biological treatment reaction zone.

Advantageously, the second treatment unit may comprise:
at least one first electro-oxidation treatment reaction zone and at least one second reaction zone selected from an electro-oxidation treatment reaction zone and a non-aerated biological treatment reaction zone, each second reaction zone being connected to a first reaction zone by a discharge line for the effluent leaving the first reaction zone, or
at least one first electro-oxidation treatment reaction zone, at least one second non-aerated biological treatment reaction zone and at least one third electro-oxidation treatment reaction zone, each second reaction zone being connected to a first reaction zone by a discharge line for the effluent exiting (in particular produced by) the first reaction zone, each third reaction zone being connected to a second reaction zone by a discharge line for the effluent exiting the second reaction zone.

Advantageously, the treatment plant may comprise recirculation line connecting an outlet of the at least one first electro-oxidation treatment reaction zone or the at least one second non-aerated biological treatment reaction zone to an inlet of a biological treatment reaction zone of the first unit.

Advantageously, the second treatment unit may comprise at least one electro-oxidation reaction zone discharge line selected from a dihydrogen discharge line and a dioxygen discharge line.

The treatment plant may also comprise at least one further treatment unit selected from:
a fourth treatment unit comprising a feed line connected to a discharge line of the second treatment unit and a discharge line for a fourth effluent, and comprising at least one reaction zone selected from a suspended materials removal treatment reaction zone, a phosphorus removal treatment reaction zone, a micropollutant removal treatment reaction zone, a microorganism removal treatment reaction zone,
a fifth treatment unit comprising a feed line connected to a discharge line for a liquid fraction of digestate from the third unit and an effluent discharge line, optionally connected to the feed line of the first unit, and comprising at least one reaction zone selected from an electrocoagulation treatment reaction zone, an electro-oxidation treatment reaction zone, a non-aerated biological treatment reaction zone for oxidation of ammonium ions by autotrophic anaerobic bacteria (Anammox reaction zone), the latter two reaction zones being preceded or not by an electrocoagulation treatment reaction zone, an outlet of the electro-oxidation treatment reaction zone being connected to an inlet of the non-aerated biological treatment reaction zone.

In particular, the electrocoagulation treatment reaction zone may comprise an electrochemical reactor equipped with a sacrificial anode comprising magnesium, and a solid-liquid separation device.

Advantageously, the treatment plant can be equipped with a control system comprising at least one device for determining a content of ammonium ions and/or nitrates and/or nitrites, at least one fluid displacement device, and a control unit configured to:
determine an amount of nitrogen present in the third or fourth effluent and in at least one effluent to be extracted selected from the first effluent, the effluent from the at least one first electro-oxidation treatment reaction zone and the effluent from the at least one non-aerated biological treatment reaction zone of the first unit,
then
determine a quantity of the at least one effluent to be extracted in order to achieve a limit nitrogen content in the third or fourth effluent and control the at least one fluid displacement device to extract said quantity of the at least one effluent to be extracted and to mix it with the third or fourth effluent, and/or
determine a quantity of the effluent from the at least one first electro-oxidation treatment reaction zone to be sent to a non-aerated biological treatment reaction zone of the first treatment unit, this quantity corresponding to a nitrate and/or nitrite content required for non-aerated biological treatment to eliminate carbonaceous matter, and control the at least one fluid displacement device to send said quantity of this effluent to said non-aerated biological treatment reaction zone of the first unit.

### DEFINITIONS/ABBREVIATIONS

Anammox: ANaerobic AMMOnium Oxidation In this reaction, under anoxic (oxygen-free) conditions, ammonium is converted to nitrogen gas using nitrite as the electron acceptor. This reaction takes place in the presence of autotrophic anaerobic bacteria (they don't need free or dissolved O₂).

BMP: Methanogenic potential, corresponds to the maximum quantity of methane produced by a compound during its anaerobic degradation. It is generally expressed as the volume (NmL) of methane produced per gram of volatile substrate material.

HRT: Hydraulic retention time.

N/DN: Nitrification/Denitrification.

Refractory carbon: Carbon that cannot be broken down by the purifying biomasses of wastewater treatment methods because the compound is too complex.

Total electro-oxidation step: A step wherein total electrochemical oxidation of the species present is carried out (total oxidation of ammonium ions to nitrogen, total oxidation of nitrites/nitrates to nitrogen).

Partial electro-oxidation step: A step wherein partial electrochemical oxidation of the species present, e.g. ammonium ions to nitrates and/or nitrites, takes place.

An electro-oxidation step (total or partial) is incomplete when only some of the ions present in the effluent are oxidized.

Biological treatment in anoxic conditions refers to treatment carried out in an environment to which no O₂ is supplied (without aeration), but where oxygen is available in the medium in the combined form of nitrates, sulfates or other elements. Conversely, treatment under oxic conditions is carried out in an environment to which O₂ oxygen is supplied.

Biological treatment can be carried out in fixed cultures, where bacteria grow as a biofilm on the surface of a support material, or in free cultures (also known as activated sludge), where bacteria grow freely in the enclosure (flocs). In the case of free-culture (or “activated sludge”) biological treatment, this includes a step for separating the bacterial culture (that is, sludge) from the treated liquid effluent. The sludge is generally returned to the biological treatment process. Separation can take place in a clarifier (settler) or filters using microfiltration or ultrafiltration membranes. If a succession of free-culture biological reactors is installed (succession of multiple biological treatments), biomass separation can be carried out downstream of the last reactor.

The term “wastewater” refers to urban wastewater, most of which is of domestic origin, but some of which may be of industrial origin, or industrial wastewater, particularly from the food industry or any other industry producing effluent loaded with carbonaceous matter and nitrogen. Preferably, the wastewater will be municipal urban wastewater.

Struvite is an ammonium-magnesium-phosphate salt with the chemical formula NH₄MgPO₄·6H₂O.

### BRIEF DESCRIPTION OF THE DRAWINGS

Further features and advantages of the invention will become apparent from the following description of several particular embodiments of the invention, given by way of indication but not limitation, with reference to the appended drawings wherein:

FIG. 1 is a schematic representation of the treatment plant according to one embodiment of the invention.

FIG. 2 is a schematic representation of the treatment plant according to a first alternative embodiment of the invention.

FIG. 3 is a schematic representation of the treatment plant according to a second alternative embodiment of the invention.

FIG. 4 is a schematic representation of the treatment plant according to a third alternative embodiment of the invention.

FIG. 5 is a schematic representation of the treatment plant according to a fourth alternative embodiment of the invention.

FIG. 6 is a schematic representation of the treatment plant according to a fifth alternative embodiment of the invention.

### DETAILED DESCRIPTION

### Method

The method according to the invention is a method for treating wastewater containing nitrogen in the form of ammonium ions (NH₄⁺) and carbonaceous matter, that is to say a method for removing nitrogen and carbonaceous matter from wastewater. This wastewater often contains suspended particles which can also be removed by the method according to the invention.

The nitrogen present in wastewater is mainly in the form of ammonium ions, but it can also be present in the form of organic nitrogen, which is ultimately transformed by bacteria into ammonium ions through an ammonification reaction.

The wastewater treatment method comprises a wastewater treatment step (a) producing a first effluent with a reduced carbon content and a second effluent with an increased carbon content, a treatment step (b) comprising at least one electro-oxidation step of at least part of the first effluent to produce a third effluent with a reduced nitrogen content and a step (c) of anaerobic digestion of the second effluent to produce biogas and digestate.

Step (a) is thus a carbon elimination step, while step (b) is a nitrogen elimination step and step (c) is a biogas production step.

The alternative configurations of the various steps of the method presented below can be combined depending on the selected treatment objective.

### Wastewater Treatment Step (a)

The wastewater treatment step (a) produces a first effluent with a reduced carbon content relative to the wastewater to be treated, and a second effluent with an increased carbon content relative to the wastewater to be treated.

This treatment step (a) is a first treatment step which may comprise at least one treatment step selected from a physical treatment step (a1), optionally preceded by a physical/chemical treatment step (a2), and a biological treatment step (a3, a4), or a combination of these steps.

The physical treatment step (a1) can be chosen from a settling step, a flotation step or a filtration step. The purpose of step (a1) is to eliminate solid particles. The physical treatment step (a1) thus produces sludge corresponding to the second effluent with increased carbon content and an effluent corresponding to the first effluent with reduced carbon content.

The physical/chemical treatment step (a2) generally comprises a coagulation (or electrocoagulation) step followed by a flocculation step. This type of treatment is typically carried out in the presence of chemical reagents, such as coagulants and/or flocculants. The coagulant can be added to the water to be treated or formed in situ (electrocoagulation). Flocculant is usually added to coagulated water. A flocculation step alone is also possible.

The physical/chemical treatment step (a2) is implemented upstream of step (a1) when present. Adding a flocculant, or a coagulant and a flocculant, upstream of physical treatment improves separation of the first and second effluents, by also eliminating colloidal organic matter that can flocculate, and speeds up the method, thus reducing plant size.

Preferentially, the physical treatment step (a1) is a settling step with or without a prior physical/chemical treatment step (a2), in particular with or without prior coagulation/flocculation.

The treatment step (a) may further comprise at least one step (a3) for biological treatment of the carbonaceous material.

The biological treatment step (a3) can be carried out under anoxic or oxic conditions suitable for eliminating the carbonaceous matter present in the treated wastewater. The treatment in anoxic conditions eliminates biodegradable carbonaceous matter through denitrification, that is to say, without the addition of oxygen through aeration. When the biological treatment is under anoxic conditions, part of the effluent produced by step (b) containing nitrates and/or nitrites is returned upstream of step (a) or in step (a), upstream or in step (a3) of biological treatment under anoxic conditions, thus eliminating residual nitrogen during the biological treatment of carbon. The treatment under oxic conditions eliminates residual biodegradable carbonaceous matter. The sequence of anoxic and then oxic conditions makes it possible to limit air intake for overall carbon removal, and thus optimize the energy requirements of said biological treatment step (a3).

Typically, the biological treatment step (a3) is carried out under nitrification-limiting conditions, that is to say, using a low sludge age (low sludge retention time). The aim of this step is to treat only the carbonaceous matter and not the nitrogen present in the wastewater. To this end, the person skilled in the art will be able to select suitable conditions by controlling, in particular, one or more of the following parameters: sludge retention time (chosen in particular as a function of the temperature of the medium), hydraulic retention time, aeration, oxygen supply, and so on. In particular, a high-load activated sludge method can be used to implement the biological treatment step (a3), or a denitrifying biofilter.

The biological treatment step (a3) thus produces sludge corresponding to the second effluent with increased material content and an effluent corresponding to the first effluent with reduced carbon content.

Preferentially, the biological treatment step (a3) is carried out under anoxic conditions. Optionally, the biological treatment step (a3) is carried out in two parts, the first under anoxic conditions and the second under oxic conditions. Biological treatment in anoxic and then oxic conditions will enable residual biodegradable carbon to be treated and produce sludge with a high methanogenic potential.

The treatment step (a) can further comprise at least one step (a4) of anaerobic biological treatment in free cultures of the carbonaceous material to advantageously biologically treat (eliminate) part of the phosphorus contained in the effluent. If step (a4) is followed by step (a3), these steps are carried out in free cultures. In this case, step (a3) comprises a separation step carried out in a clarifier, for example. The separated activated sludge is then returned to step (a4).

In a first embodiment, the treatment step (a) may comprise:
at least one physical treatment step (a1) or physical/chemical treatment step (a2), or the succession of at least one physical/chemical treatment step (a2) and at least one prior physical treatment step (a1) (such as a settling or filtration step with or without coagulation/flocculation),
followed by at least one biological treatment step (a3) to eliminate the carbonaceous matter present in the effluent from the physical treatment step (a1) or the physical/chemical treatment step (a2).

The sludge from steps (a1), (a2), (a3) can then be combined to form the second effluent with an increased carbon content.

In a second embodiment, treatment step (a) may comprise:
at least one step (a1) of physical treatment or (a2) of physical/chemical treatment or the succession of at least one step (a2) of physical/chemical treatment and at least one step (a1) of physical treatment,
followed by at least one anaerobic biological treatment step (a4) to eliminate phosphorus from the effluent,
followed by at least one biological treatment step (a3) to eliminate the carbonaceous matter present in the effluent under anoxic and/or oxic conditions.

The sludge from the physical (a1) and/or physical/chemical treatment (a2) steps and the biological (a3) (a4) treatment steps is advantageously combined to form the second effluent with an increased carbon content.

The person skilled in the art will be able to choose step (a), and in particular one or more of the steps (a1), (a2), (a3), (a4) previously described, in the usual way, depending on several factors, in particular the size of the plant, the quality of the wastewater to be treated and in particular its nitrogen and carbon content. In addition, the operator can choose the most suitable conditions for this step (a) to maximize the carbon content of the second effluent.

### Electro-Oxidation Treatment Step (b)

The first effluent from the treatment step (a) is then treated by electro-oxidation to produce a third effluent with a reduced nitrogen content. In step (b), at least some of the ammonium ions contained in the first effluent are oxidized to nitrite and/or nitrate and/or nitrogen.

Electro-oxidation, also known as anodic oxidation or electrochemical oxidation, is an advanced oxidation process. Electro-oxidation can be direct or indirect. Electro-oxidation is direct when electrons are exchanged directly between the surface of an electrode and the ions (ammonium ions) adsorbed on the electrode surface. Electro-oxidation is indirect when electrons are exchanged with the help of intermediate oxidizing agents. These oxidants can be generated at the surface of an electrode by transferring electrons to ions present in the water (chlorides, sulfates) or directly to the water (water electrolysis). The main oxidants generated at the surface of an electrode in wastewater are hydroxyl radicals (HO^{-·}), sulfate radicals (SO₄^{-·}), hypochlorous acid (HClO), ozone (O₃) or hydrogen peroxide (H₂O₂). For example, ammonium ions can be treated by oxidation of ammonium ions to nitrates and/or nitrites at the anode, while reduction of nitrites and/or nitrates to N₂ takes place at the cathode. Alternatively, ammonium ions can be directly oxidized to N₂ at the anode. Water electrolysis results in the production of H₂ (gas) at the cathode and O₂ (gas) at the anode. This electrolysis can occur whether the electro-oxidation is partial or total.

Electro-oxidation is a well-known process which will not be described in greater detail here. Electro-oxidation is typically controlled by varying the current density applied between the electrodes and the effluent flow rate entering the electro-oxidation chamber (retention time).

During this electro-oxidation step, organic matter, in particular refractory carbonaceous matter, and/or organic micropollutants still present can be eliminated by partial or total indirect electro-oxidation, thus achieving low carbon levels in the treated water.

What's more, the reaction intermediates (intermediate oxidants), which are by nature non-selective oxidants, act on the microorganisms, enabling the partial or even total disinfection of the treated water.

The step (b) may comprise, or consist of, a step of total electro-oxidation of ammonium ions to dinitrogen.

Alternatively, step (b) may comprise, or consist of, one or more electro-oxidation steps, for example a partial electro-oxidation step of at least some of the ammonium ions to nitrates and/or nitrites followed by a total electro-oxidation step of at least some of the nitrates and/or nitrites to dinitrogen, optionally with an intermediate Anammox step.

In one embodiment, nitrogen removal step (b) may thus comprise a partial electro-oxidation step (b1) of at least some of the ammonium ions to nitrates and/or nitrites.

At the end of this partial electro-oxidation step (b1), at least part of the effluent produced can be sent to treatment step (a). Recycling part of the effluent produced will optimize the energy requirement for carbon removal when treatment step (a) contains a biological treatment step (a3) in anoxic conditions.

The recycling process is advantageously carried out upstream or in step (a3) of biological treatment of the carbonaceous material. Preferentially, this recycling is carried out upstream or in step (a3) of biological treatment under anoxic conditions. The presence of nitrites and/or nitrates in this recycling process means that the aeration normally required for carbon removal by non-nitrifying biological treatment can be totally or partially eliminated.

The step of partial electro-oxidation (b1) of the ammonium ions can then be followed by a step of total electro-oxidation (b2) of at least some of the nitrates and/or nitrites into dinitrogen. In step (b2), at least some of the nitrates/nitrites are reduced to dinitrogen, but some of the ammonium ions not oxidized in step (b1) may also be oxidized in this step.

The total electro-oxidation step (b2) of at least some of the nitrates and/or nitrites is designed to complete the removal of total nitrogen and to achieve a total nitrogen limit set by operators or by discharge standards. This limit can be verified by direct measurement of the ammonium and/or nitrate and/or nitrite ion content using appropriate sensors and/or analyzers.

In a third alternative embodiment, step (b) may comprise the partial electro-oxidation step (b1) of some of the ammonium ions followed by a biological treatment step (b3) by oxidation of at least some of the ammonium ions by autotrophic anaerobic bacteria, also known as Anammox, and optionally followed by a total electro-oxidation step (b2) of at least some of the nitrates and/or nitrites to dinitrogen.

The Anammox treatment step (b3) is thus coupled to the partial electro-oxidation step (b1) of ammonium ions to nitrates/nitrites. At the end of the partial oxidation step (b1), only some of the ammonium ions have been oxidized. The Anammox treatment step (b3) involves anaerobic autotrophic bacteria that consume ammonium ions and nitrite to produce N₂ without the need for oxygen and biodegradable carbon. The input to the Anammox treatment step (b3) therefore requires both ammonium ions and nitrites, which are supplied by the incomplete partial oxidation step (b1). The combination of steps (b1) and (b3) reduces the overall energy consumption for nitrogen removal, particularly as the optional downstream nitrate/nitrite total electro-oxidation step (b2) does not have to oxidize all the ammonium ions not treated by step (b1) and all the nitrate/nitrite ions formed by step (b1).

This implementation also enables better and more stable control of the NH₄/NOₓ ratio at the Anammox inlet, as partial electro-oxidation can be controlled with the current density applied. The partial electro-oxidation step (b1) can thus be implemented so as to obtain an effluent with a nitrite/ammonia ion concentration ratio that favors treatment by Anammox bacteria. This ratio is, for example, from 0.8 to 1.8, preferably from 1.1 to 1.5 gN/gN.

However, the Anammox treatment step (b3) may not achieve a high ammonium ion removal rate, leading to a breakthrough of ammonium and nitrite ions at the treatment outlet, which must be converted to nitrate or even partially to N₂ to comply with a strict discharge standard. It is then preferable to follow the Anammox treatment step (b3) with the step (b2) of total electro-oxidation of at least part of the remaining nitrates and/or nitrites and/or ammonium into dinitrogen.

Optionally, whatever the embodiment of the invention and in particular step (b), the H₂ gas produced at the cathode during electrolysis of the water may occur during the electro-oxidation step (b), and in particular during the steps of partial electro-oxidation (b1) of ammonium ions to nitrite/nitrate and/or electro-oxidation (b2) of at least some of the nitrates and/or nitrites to dinitrogen, can be recovered for reuse.

Optionally, the O₂ gas produced at the anode during the electrolysis of water that may occur during the electro-oxidation step (b), and in particular during the steps of partial electro-oxidation (b1) of ammonium ions to nitrite/nitrate and/or total electro-oxidation (b2) of at least some of the nitrates and/or nitrites to dinitrogen, may be recovered for recovery, or re-injected into biological treatment step (a3) to eliminate carbonaceous matter and reduce energy requirements when this step is carried out partially or totally under oxic conditions.

### Optional Step (d) of the Third Effluent Produced by Step (b)

Optionally, treatment step (b) is followed by a treatment step (d) for the third effluent produced. The treatment step (d) of the third effluent may comprise at least one treatment selected from a suspended materials removal treatment, a phosphorus compounds removal treatment, a micropollutants removal treatment, a microorganisms removal treatment.

The suspended materials removal treatment step can be a physical or physical/chemical treatment as described in step (a). This may involve a settling, filtration or flotation step with or without, preferentially with, prior coagulation/flocculation.

The treatment step for removing phosphorus compounds can be a physical or physical/chemical treatment of the type described above, with the addition of a coagulant supplied via a chemical reagent or by electrocoagulation, with the aim of removing phosphorus compounds.

The treatment step for removing micropollutants or microorganisms may comprise at least one treatment selected from electrocoagulation, advanced oxidation such as ozonation or electro-oxidation or by injection of a strong oxidant (e.g. ferrate), an adsorption step on activated carbon, disinfection using oxidants (e.g. chlorine, peracids), ultraviolet rays, peracids or chlorine.

The step (d) of treating the third effluent is designed to further clean the water when it is discharged into a sensitive ecosystem or for reuse. The treatment step (d) produces a fourth effluent with a nitrogen and carbon content, a micropollutant content and/or a microorganism content in compliance with specifications set by the operator or by law, which can be discharged into the environment or reused.

### Optional Control Step

The treatment method may further comprise a step for controlling the wastewater treatment step (a) and the electro-oxidation treatment step (b).

The control step controls the quantity of first effluent entering the treatment step (b) and/or one of the steps (b1), (b2) (b3) of step (b). Alternatively, or in combination, the control step can be used to control the amount of effluent produced in the partial electro-oxidation step (b1) of ammonium ions that can be recycled in step (a).

In the control step, first (i1) an amount of nitrogen present in the third effluent or fourth effluent and in at least one effluent to be extracted selected from the first effluent of step (a), the effluent of the partial electro-oxidation step (b1) of ammonium ions, and the effluent of step (b3) Anammox is determined. The amount of nitrogen can be measured directly by an ammonium ion and/or nitrate/nitrite sensor. The amount of nitrogen can also be measured indirectly using ammonia analyzers.

Next, in (i2), a quantity of the at least one effluent to be extracted is determined in order to achieve a limit nitrogen content in the third or fourth effluent, and said quantity of the at least one effluent to be extracted is extracted and mixed with the third or fourth effluent. To this end, the amount of nitrogen measured in the third or fourth effluent can be used to determine the amount of the at least one effluent to be extracted so that, combined with the third or fourth effluent, the total amount of nitrogen in the latter does not exceed a limit nitrogen content. The authorized nitrogen content limit, particularly for ammonium ions, can be chosen according to the nitrogen discharge limits authorized by law. Once the quantity of effluent to be extracted has been calculated on the basis of measurements taken on the third or fourth effluent and the at least one effluent to be extracted, this quantity is extracted and injected into the third or fourth effluent.

In the step of controlling the recycling of part of the effluent produced in the partial electro-oxidation step (b1) of ammonium ions, a quantity of the effluent drawn from the partial electro-oxidation step (b1) to be sent to the biological treatment step of step (a) is determined (i3). This quantity can be determined using nitrate/nitrite/ammonia sensors or analyzers. This quantity corresponds to a nitrite and/or nitrate content enabling carbonaceous matter to be removed from the wastewater entering said biological treatment step (a3). In particular, it is possible to determine the amount of carbonaceous matter in the wastewater in order to determine the quantity of effluent to be recycled. This quantity of effluent is then sent to a biological treatment step (a3) of step (a), preferentially when this step is carried out under anoxic conditions. The recycling process also reduces the energy required for the second electro-oxidation step (b2).

### Anaerobic Digestion Step (c)

The second effluent from treatment step (a) is treated by an anaerobic digestion step (c) to produce biogas and digestate.

Anaerobic digestion or methanization is a cascade of biochemical reactions enabling methanogenic bacteria to convert the organic matter present in a digester into biogas, mainly a mixture of carbon dioxide and methane. The remaining material is called digestate.

The conditions under which step (c) is carried out, in particular temperature, pH and retention time, can advantageously be chosen to maximize biogas production.

The anaerobic digestion step (c) can further comprise, or be followed by, a digestate liquid-solid separation step to separate the digestate into a solid fraction and a liquid fraction. This separation step can be a digestate dewatering step producing a solid fraction (dewatered sludge) and a liquid fraction, such as a centrifugation or filtration step.

Optionally, at least one pre-treatment step of the second effluent upstream of the anaerobic digestion step (c) can be implemented to increase its yield. This pre-treatment step can be selected from chemical, mechanical, biological and thermal pre-treatment steps.

The chemical pre-treatment step may be acid or base hydrolysis or advanced oxidation. During the chemical pretreatment step, the sludge can be heated to a temperature below 100° C.

The mechanical pretreatment step can be an ultrasonic, microwave or electrokinetic disintegration step.

The biological pre-treatment step is, for example, a fermentation/hydrolysis step under mesophilic (30-42° C.) or thermophilic (45-70° C.) conditions, with a retention time of around 1 to 3 days.

Finally, the thermal pre-treatment step can be a thermal hydrolysis process (THP). The thermal hydrolysis process (THP) involves heating sludge to a temperature generally between 140° C. and 180° C., with a treatment time of 30 minutes to 60 minutes.

Optionally, a post-treatment step can also be carried out at the outlet of anaerobic digestion treatment step (c) for the second effluent. Indeed, the digested sludge resulting from anaerobic digestion step (c) contains a large amount of non-biodegradable organic matter that can be used for additional energy production. The post-treatment step is typically a hydrothermal carbonization (HTC) process. This process typically operates at temperatures between 180° C. and 280° C. for a period ranging from a few minutes to several hours in a non-oxidizing atmosphere. Wet dewatered sludge is treated with pressurized steam and the process produces a solid carbon fraction and a liquid fraction. The liquid fraction can be returned to anaerobic digestion step (c) to increase biogas production.

### Optional Additional Treatment Step (e) for the Liquid Fraction of the Digestate Produced by Step (c)

In one embodiment, the anaerobic digestion step (c) of the second effluent can be followed by an additional treatment step (e) of at least part of the liquid fraction of the digestate produced by digestion step (c). The effluent produced by the additional step (e) can then be returned to the method input stream for effluent recycling. Recycling this flow optimizes the process by treating as much wastewater as possible, thus reducing the load contained in these returns.

The additional treatment step (e) can be selected from an electrocoagulation treatment step (e0), an electro-oxidation treatment step (e1), a biological treatment step (e2) involving the oxidation of ammonium ions by autotrophic anaerobic bacteria (Anammox treatment) and the succession of these last two steps (e1) (e2), preceded or not by step (e0). The solid biomass fraction produced by this Anammox step (e2) can be returned to the input of digestion step (c).

The additional step (e) treats a liquid fraction rich in ammonium ions to reduce its nitrogen content so that it can be redirected into the main water line at the start of step (a) or during step (a).

Preferentially, the liquid fraction treatment step of the additional step (e) is an electro-oxidation step which is a total oxidation of ammonium ions to dinitrogen. In this configuration, electro-oxidation would also oxidize dissolved carbon and should not be affected by variations in the capture rate of the sludge pre-treatment process. The high temperature and high nitrogen load also provide favorable conditions for electro-oxidation kinetics.

Alternatively, the liquid fraction treatment step of additional step (e) is an electro-oxidation step followed by an Anammox treatment step. In this case, the electro-oxidation step is an incomplete partial electro-oxidation of ammonium ions to nitrate/nitrite. This leads to improved and stable control of the NH₄/NOₓ ratio, as explained in step (b). The energy balance is also improved, as only part of the liquid fraction of the digestate undergoes electro-oxidation, reducing the associated energy requirement.

Optionally, the additional step (e) comprises an electrocoagulation treatment step (e0) comprising a first sub-step for precipitating the phosphorus and ammonium contained in the liquid fraction of the digestate in the form of struvite by implementing electrocoagulation with a sacrificial anode comprising magnesium, coupled with a sub-step for separating the struvite formed, which may be, for example, filtration or settling. The advantage of this step (e0) is that it reduces the amount of nitrogen to be oxidized by subsequent steps, while producing a resource (struvite) with high agronomic added value (fertilizer), without the addition of external chemical reagents, as the magnesium required for precipitation comes from electrocoagulation.

### Installation Description

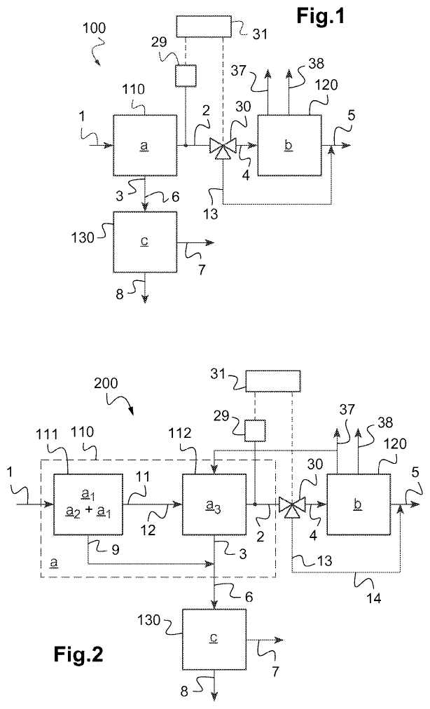

With reference to FIG. 1, the plant 100 for treating wastewater containing nitrogen mainly in the form of ammonium ions and carbonaceous material comprises a first wastewater treatment unit 110 suitable for implementing step (a) of the method, a second electro-oxidation treatment unit 120 suitable for implementing step (b) of the method, and a third anaerobic digestion treatment unit 130 suitable for implementing step (c) of the method.

The first wastewater treatment unit 110 is configured to be fed by a wastewater feed line 1 containing nitrogen partly in the form of ammonium ions and carbonaceous material and to produce a first effluent with a reduced carbonaceous material content discharged into a first discharge line 2 and a second effluent with an increased carbonaceous material content discharged into a second discharge line 3. The first treatment unit 110 can b physical, physical/chemical or biological treatment unit. To this end, it may comprise one or more treatment reaction zones, selected from a filtration reaction zone, a settling reaction zone, a flotation reaction zone, a coagulation reaction zone, a flocculation reaction zone, an electrocoagulation reaction zone and a biological treatment reaction zone (with aeration for treatment under oxic conditions or without aeration for treatment under anoxic conditions). In particular, one or more reaction zones can be set up in parallel and/or in series for each physical (a1), physical/chemical (a2) or biological (a3, a4) treatment step.

A reaction zone may comprise a reactor or a treatment chamber. When the reactor or treatment chamber implements a free-culture biological treatment, the reaction zone may comprise a settling-based (clarifier) or filtration-based separation system.

In the example shown in FIG. 1, the first unit 110 may comprise one or more biological treatment reaction zones, for example a single sequential reactor (SBR), a continuous-feed free-suspension culture reactor (activated sludge) or Biofilter reactor (reactor using thin, regularly renewed biological films), or several separate reactors, notably with recirculation between them. The use of separate reactors enables continuous effluent treatment. In any case, the invention is not limited by the number of reactors used, in particular multiple reactors each operating according to aerated/non-aerated cycles can be provided, or multiple continuous feed reactors or successive reactors comprising SBRs and continuous feed reactors can be provided. When the first unit 110 contains an aerobic biological treatment reaction zone, it will be sized so as not to carry out biological nitrification.

The second electro-oxidation treatment unit 120 is configured to be supplied with a first effluent via a supply line 4 connected to the first discharge line 2 of the first treatment unit 110, and to discharge a third effluent with a reduced nitrogen content via a discharge line 5. To this end, the second unit 120 comprises at least one electro-oxidation reaction zone for carrying out the at least one electro-oxidation step. In the example shown in FIG. 1, the second treatment unit 120 comprises one or more electro-oxidation reaction zones connected in series and/or parallel. In particular, the reaction zone(s) may implement total or partial oxidation. The second unit 120 furthermore lacks an aerobic biological treatment reaction zone. The second unit 120 may further comprise a dioxygen discharge line 37 and a dihydrogen discharge line 38 from an electro-oxidation reaction zone.

The first discharge line 2 and the supply line 4 are also connected, here via a valve 30, to an optional bypass line 13. The discharge bypass line 13 is connected to the discharge line 5 for the third effluent.

The third treatment unit 130 employing anaerobic digestion comprises a feed line 6 connected to the second line 3 of the first treatment unit 110, a biogas discharge line 7 and a digestate discharge line 8. The third unit 130 may comprise one or more anaerobic digestion reaction zones, in particular connected in series and/or in parallel.

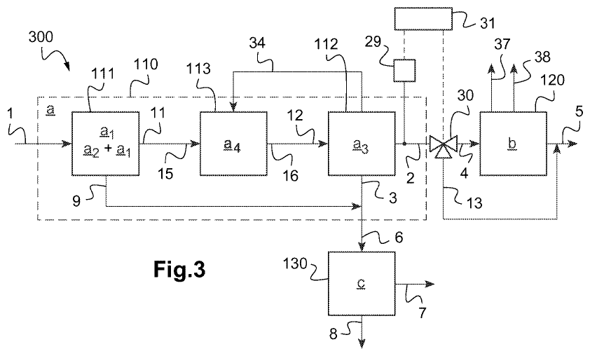

FIGS. 2 and 3 show alternative plant configurations, in particular for implementing wastewater treatment step (a). FIGS. 2 and 3 respectively show a wastewater treatment plant 200 and 300 comprising a first wastewater treatment unit 110, a second electro-oxidation treatment unit 120, and a third 130 anaerobic digestion treatment unit. As these units 120 and 130 are unchanged from FIG. 1, the numbering remains the same for these units and the pipes concerned.

With reference to FIG. 2, the first wastewater treatment unit 110 comprises a physical and/or physical/chemical wastewater treatment unit 111 suitable for carrying out steps a1) or a2)+a1) and a biological treatment unit 112 suitable for carrying out step a3) of the method. The biological treatment unit 112 comprises one or more reaction zones. If biological treatment is carried out in free cultures, then the last reaction zone of the unit comprises a biomass separation system such as a clarification chamber, not shown in the figure.

The physical and/or physical/chemical treatment unit 111 is supplied via the wastewater supply line 1 and comprises a discharge line 9 for part of the second effluent and a discharge line 11 for the effluent produced.

The biological treatment unit 112 comprises a feed line 12 connected to the discharge line 11 of the unit 111. It is also connected to the first discharge line 2 for the first effluent and comprises a second discharge line 3 for part of the second effluent. The first discharge line 2 is connected to the supply line 4 of the second unit 120 and optionally to a bypass line 13, as described with reference to FIG. 1. Finally, unit 112 can receive the oxygen circulating in pipe 37 described with reference to FIG. 1.

FIG. 3 differs from FIG. 2 by the addition of an intermediate unit 113 between units 111 and 112, capable of implementing step a4) of the method by means of one or more biological treatment reaction zones. The unit 113 is an anaerobic biological treatment unit comprising a feed line 15 connected to the discharge line 11 of the unit 111 and a discharge line 16 connected to feed line 12 of the unit 112. The unit 112 further comprises a sludge recirculation pipe 34 connected to the anaerobic biological treatment unit 113. The recirculation pipe 34 is only present if the biological treatments in units 112 and 113 are carried out in free cultures.

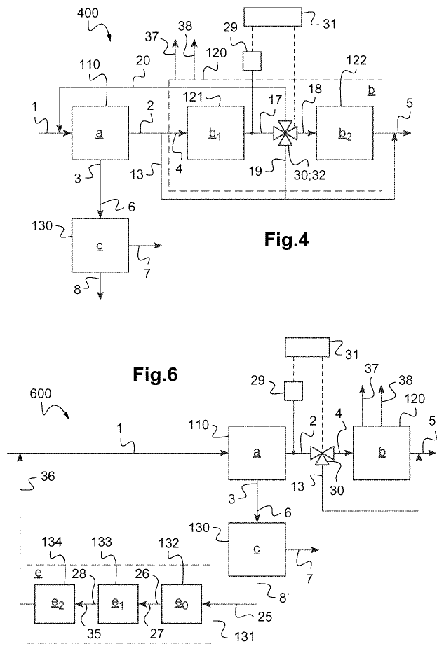

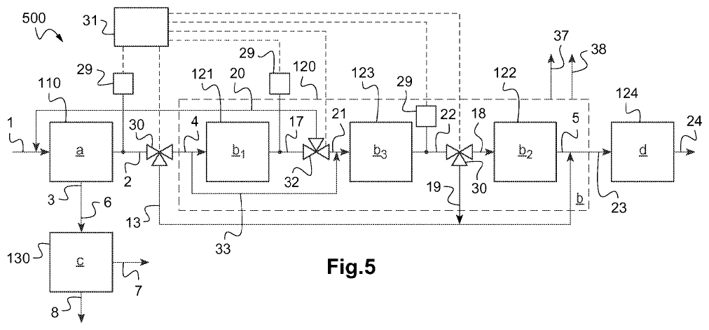

FIGS. 4 and 5 show alternative plant configurations, in particular for implementing the wastewater electro-oxidation treatment step (b). FIGS. 4 and 5 respectively show a wastewater treatment plant 400 and 500 comprising a first wastewater treatment unit 110, a second electro-oxidation treatment unit 120, and a third 130 anaerobic digestion treatment unit. As these units 110 and 130 are unchanged from FIG. 1, the numbering remains the same for these units and the pipes concerned.

With reference to FIG. 4, the second electro-oxidation treatment unit 120 comprises a treatment unit 121 for partial electro-oxidation of ammonium ions to nitrate/nitrite ions, suitable for carrying out process step b1), and a treatment unit 122 for total electro-oxidation of nitrate/nitrite ions to dinitrogen, suitable for carrying out step b2) of the method. Each unit 121, 122 comprises one or more electro-oxidation reaction zones.

The partial electro-oxidation treatment unit 121 is supplied with the first effluent via the supply line 4 connected to the discharge line 2 of unit 110, and includes a discharge line 17 for an output effluent from step b1). The discharge pipe 17 is connected, here by a valve 30, 32 to at least one pipe, here three pipes: a supply pipe 18 for unit 122, an optional recirculation pipe 20 for part of the effluent produced upstream of unit 110 and a bypass pipe 19 for part of the effluent produced. The bypass pipe 19 is connected to the bypass pipe 13 and to the third effluent discharge pipe 5. The optional recirculation pipe 20 preferentially returns the effluent produced upstream of the treatment unit 112 implementing step a3) of the first treatment unit 110 (not shown in FIG. 4).

The total electro-oxidation treatment unit 122 comprises a feed line 18 connected to the discharge line 17 of the unit 121, and the third effluent it produces exits through the discharge line 5.

FIG. 5 differs from FIG. 4 by the addition of an intermediate unit 123 located between the units 121 and 122 and suitable for implementing step (b3) of the method. The unit 123 comprises one or more non-aerated biological treatment reaction zones. The unit 123 is an Anammox treatment unit comprising a feed line 21 connected to the discharge line 17 of the unit 121 and a discharge line 22 connected to feed line 18 of the unit 122 and to the bypass line 19. The feed line 21 of the unit 123 is also connected to a bypass line 33 for some of the first effluent from the discharge line 2 of the unit 110.

The plant shown in FIG. 5 features an optional fourth unit 124 suitable for implementing the third effluent treatment step (d). Treatment unit 124 comprises a supply line 23 connected to the discharge line 5 of the unit 122 and a discharge line 24 for the fourth effluent. The fourth unit may comprise one or more treatment reaction zones connected in series and/or in parallel.

FIG. 6 shows an alternative configuration of the treatment plant, in particular downstream of the anaerobic digestion unit. FIG. 6 shows a wastewater treatment plant 600 comprising a first wastewater treatment unit 110, a second electro-oxidation treatment unit 120, and a third 130 anaerobic digestion treatment unit. As these units 110, 120 and 130 are unchanged from FIG. 1, the numbering remains the same for these units and the pipes concerned, with the exception of unit 130, which features a pipe 8′ for discharging a liquid fraction of the digestate produced.

Referring to FIG. 6, the plant comprises a fifth unit 131 suitable for implementing additional step e) of the method.

The fifth unit 131 comprises an optional electrocoagulation treatment unit 132 suitable for performing step e0), an electro-oxidation treatment unit 133 suitable for performing step e1) and an optional Anammox treatment unit 134 suitable for performing step e2). Each unit may comprise one or more appropriate treatment reaction zones connected in series and/or in parallel.

The unit 132 comprises a supply line 25 connected to the discharge line 8′ of the unit 130 and a discharge line 26 for the effluent produced.

In this embodiment, the third unit 130 comprises a liquid-solid separation system (not shown) for separating the digestate into a solid fraction and a liquid fraction. The liquid fraction is then discharged through the discharge pipe 8′. Note that this liquid-solid separation system could be external to the third unit 130 and located between it and the fifth unit 131.

The unit 133 comprises a supply line 27 connected to the discharge line 26 of the unit 132 and a discharge line 28 for the effluent produced.

The unit 134 comprises a supply line 35 connected to the discharge line 28 of unit 132 and a discharge line 36 for the effluent produced, sending this effluent into the wastewater supply line 1.

The treatment plants 100, 200, 300, 400, 500, 600 described above can further comprise a method control system for implementing steps (i1), (i2) and (i3) of the control step. With reference to FIGS. 1 to 6, the control system comprises at least one device 29 for determining an ammonium and/or nitrate and/or nitrite ion content, at least one fluid displacement device 30 and a control unit 31. The control unit 31 is configured to implement:
step (i1) from measurements received from the at least one determination device 29,
step (i2) from the quantities determined in step (i1) and controlling the at least one fluid displacement device 30,
step (i3) from the quantities determined in step (i1) and controlling the at least one fluid displacement device 30.

The at least one determination device 29 may be one or more effluent nitrogen content sensors. The at least one device 29 can be installed in the discharge line 5 of the third effluent or in the discharge line 24 of the fourth effluent and in at least one line selected from the first discharge line 2 of the first effluent with a reduced carbon content, the discharge line 17 of the effluent leaving the partial electro-oxidation step and optionally the discharge line 22 of part of the effluent produced by the Anammox b3) step.

The quantities measured by the at least one determining device 29 are sent to the control unit 31, which calculates the quantity of fluid to be extracted through the bypass pipes and controls the displacement of this quantity. The control unit 31 may comprise a computer, or more generally at least one processor or any other type of digital computer. The control unit 31 may also comprise a plurality of separate digital processors or computers, forming different means of the device, cooperating with one another.

The at least one fluid displacement device 30 may comprise one or more valves, for example a three- or four-way valve, the third way of which leads to the bypass line 13 and optionally to the bypass line 19. The at least one device 30 may further comprise one or more positive-displacement pumps (or any pump associated with a variable frequency drive and a flow meter to adjust the flow rate) capable of withdrawing a calculated quantity of fluid to be extracted. The bypass pipes connected to the valves also form displacement devices within the meaning of the invention.

Referring to FIGS. 4 and 5, for controlling the recycling of effluent from the first electro-oxidation treatment unit, the control system comprises a device for determining 29 an ammonium and/or nitrate and/or nitrite ion content, a fluid displacement device 32 and the control unit 31.

The determination device 29 may be an effluent nitrogen content sensor. Here, it is installed in the discharge line 17 for the effluent leaving the partial electro-oxidation treatment unit 121.

The measured quantity is sent to control unit 31, which calculates the quantity of fluid to be recycled, corresponding to the nitrate and/or nitrite content required for an anoxic biological treatment to eliminate carbonaceous matter. The control unit 31 also controls the displacement of the fluid quantity to be recycled.

The fluid displacement device 32 may be a three-way or four-way valve, with one of the ways leading to the recirculation line 20. The device 32 can also be a positive-displacement pump (or any pump associated with a frequency converter and a flowmeter) capable of taking the calculated quantity to be recycled.

The various embodiments shown in FIGS. 1 to 6 can be combined according to the treatment objective selected.

1. A method for treating wastewater containing nitrogen in the form of ammonium ions and carbonaceous material, said method comprising:
(a) a wastewater treatment step to produce a first effluent with a reduced carbon content and a second effluent with an increased carbon content,
(b) a step for treating at least part of the first effluent to produce a third effluent with a reduced nitrogen content, and,
(c) an anaerobic digestion step for the second effluent to produce biogas and digestate;
said method being characterized in that treatment step (b) is carried out without implementing biological nitrification under aerobic conditions and comprises at least one electro-oxidation step during which at least some of the ammonium ions contained in the first effluent are oxidized to nitrites and/or nitrates, and/or to dinitrogen.

2. The wastewater treatment method according to claim 1, characterized in that the treatment step (a) comprises at least one carbonaceous material treatment step selected from a physical treatment step (a1), optionally preceded by a physical/chemical treatment step (a2), and a biological carbonaceous material treatment step (a3, a4).

3. The wastewater treatment method according to claim 2, characterized in that the physical treatment step (a1) is selected from a settling step, a flotation step and a filtration step, and the physical/chemical treatment step (a2) is selected from a coagulation-flocculation step, a flocculation step alone and an electrocoagulation step followed by flocculation.

4. The wastewater treatment method according to claim 1, characterized in that step (b) comprises a step of total electro-oxidation of at least some of the ammonium ions to dinitrogen.

5. The wastewater treatment method according to claim 1, characterized in that step (b) comprises a partial electro-oxidation step (b1) of at least some of the ammonium ions to nitrates and/or nitrites.

6. The wastewater treatment method according to claim 5, characterized in that step (b) comprises:
(i) the partial electro-oxidation step (b1) wherein part of the ammonium ions are oxidized to nitrates and/or nitrites, followed by a step (b3) of anoxic biological treatment by oxidation of the ammonium ions by autotrophic anaerobic bacteria, or
(ii) the partial electro-oxidation step (b1) wherein at least some of the ammonium ions are oxidized to nitrates and/or nitrites, followed by a total electro-oxidation step (b2) of at least some of the nitrates and/or nitrites to dinitrogen, or
(iii) the partial electro-oxidation step (b1) wherein some of the ammonium ions are oxidized to nitrates and/or nitrites, followed by a step (b3) of anoxic biological treatment by oxidation of the ammonium ions by autotrophic anaerobic bacteria and then a step of total electro-oxidation (b2) of at least some of the nitrates and/or nitrites to dinitrogen.

7. The wastewater treatment method according to claim 6, characterized in that at least part of the effluent produced by said partial electro-oxidation step (b1) or by the anoxic biological treatment step (b3) is sent to the treatment step (a), upstream or in an anoxic biological treatment step (a3) for the carbonaceous matter from step (a).

8. The wastewater treatment method according to claim 6, characterized in that during the electro-oxidation step (b), (b1) or (b2), electrolysis of water present in the effluent takes place, resulting in the production of dihydrogen at the cathode and dioxygen at the anode, and that the dihydrogen and/or dioxygen is recovered, and optionally the dioxygen is sent to the treatment step (a), upstream or in a biological treatment step (a3) for the carbonaceous matter from step (a).

9. The wastewater treatment method according to claim 1, characterized in that said method further comprises a treatment step (d) for the third effluent produced by treatment step (b) to produce a fourth effluent, this treatment step (d) comprising at least one treatment chosen from a suspended material removal treatment, a phosphorus compounds removal treatment, a micropollutants removal treatment, a microorganisms removal treatment.

10. The wastewater treatment method according to claim 6, characterized in that said method further comprises a control step wherein:
(i1) a quantity of nitrogen present in the third effluent or the fourth effluent and in at least one effluent to be extracted chosen from the first effluent, the effluent from the step of partial electro-oxidation (b1) of ammonium ions, and the effluent from step (b3) of anoxic biological treatment by oxidation of ammonium ions by autotrophic anaerobic bacteria is determined,
then
(i2) a quantity of the at least one effluent to be extracted is determined in order to achieve a limit nitrogen content in the third or fourth effluent, and said quantity of the at least one effluent to be extracted is extracted and mixed with the third or fourth effluent, and/or
(i3) a quantity of the effluent from the partial electro-oxidation step (b1) of the ammonium ions to be sent to an anoxic biological treatment step (a3) of step (a) is determined, this quantity corresponding to a nitrate and/or nitrite content necessary for an anoxic biological treatment to eliminate carbonaceous matter, and said quantity of this effluent is sent to the anoxic biological treatment step (a3) of step (a).

11. The wastewater treatment method according to claim 1, characterized in that said method further comprises at least one treatment step (e) for at least part of a liquid fraction of the digestate produced by digestion step (c), this treatment step being selected from an electrocoagulation treatment step (e0), an electro-oxidation treatment step (e1) during which at least some of the ammonium ions contained in said liquid fraction are oxidized to nitrites and/or nitrates, and/or to dinitrogen, an anoxic biological treatment step (e2) by oxidation of ammonium ions by autotrophic anaerobic bacteria and the succession of the two steps (e1) (e2), preceded or not by step (e0).

12. The wastewater treatment method according to claim 11, characterized in that the electrocoagulation treatment step (e0) comprises a sub-step of struvite precipitation by electrochemical dissolution of a sacrificial anode comprising magnesium, coupled with a sub-step of separation of the precipitated struvite.

13. A treatment plant for the treatment of wastewater containing nitrogen in the form of ammonium ions and carbonaceous material, comprising:
a first wastewater treatment unit comprising a wastewater feed line, a first discharge line for a first effluent with a reduced carbon content and a second discharge line for a second effluent with an increased carbon content,
a second treatment unit, comprising a feed line connected to the first line of the first wastewater treatment unit and a discharge line for a third effluent having a reduced nitrogen content, the second treatment unit comprising at least one electro-oxidation treatment reaction zone and being devoid of an aerobic biological treatment reaction zone,
a third treatment unit employing anaerobic digestion, comprising a feed line connected to the second line of the first treatment unit, a biogas discharge line and a digestate discharge line.

14. The treatment plant according to claim 13, characterized in that the first wastewater treatment unit comprises at least one reaction zone selected from a physical treatment reaction zone, optionally coupled to a physical/chemical treatment reaction zone, and a biological treatment reaction zone.

15. The treatment plant according to claim 13, characterized in that the second treatment unit comprises:
at least one first electro-oxidation treatment reaction zone and at least one second reaction zone selected from an electro-oxidation treatment reaction zone and a non-aerated biological treatment reaction zone, each second reaction zone being connected to a first reaction zone by a discharge line for the effluent leaving the first reaction zone, or
at least one first electro-oxidation treatment reaction zone, at least one second non-aerated biological treatment reaction zone and at least one third electro-oxidation treatment reaction zone, each second reaction zone being connected to a first reaction zone by a discharge line for the effluent produced by the first reaction zone, each third reaction zone being connected to a second reaction zone by a discharge line for the effluent exiting the second reaction zone.

16. The treatment plant according to claim 15, characterized in that the treatment plant comprises a recirculation line connecting an outlet of the at least one first electro-oxidation treatment reaction zone or the at least one second non-aerated biological treatment reaction zone to an inlet of a biological treatment reaction zone of the first wastewater treatment unit.

17. The treatment plant according to claim 13, characterized in that the treatment plant comprises at least one further treatment unit selected from:
a fourth treatment unit comprising a feed line connected to a discharge line of the second treatment unit and a discharge line for a fourth effluent, and comprising at least one reaction zone selected from a suspended materials removal treatment reaction zone, a phosphorus removal treatment reaction zone, a micropollutant removal treatment reaction zone, a microorganism removal treatment reaction zone,
a fifth treatment unit comprising a feed line connected to a discharge line for a liquid fraction of digestate from the third unit and an effluent discharge line, optionally connected to the feed line of the first wastewater treatment unit, and comprising at least one reaction zone selected from an electrocoagulation n treatment reaction zone, an electro-oxidation treatment reaction zone, a non-aerated biological treatment reaction zone for oxidation of ammonium ions by autotrophic anaerobic bacteria, the latter two reaction zones being preceded or not by an electrocoagulation treatment reaction zone, an outlet of the electro-oxidation treatment reaction zone being connected to an inlet of the non-aerated biological treatment reaction zone.

18. The treatment plant according to claim 13, characterized in that the treatment plant is equipped with a control system comprising at least one device for determining a content of ammonium ions and/or nitrates and/or nitrites, at least one fluid displacement device, and a control unit configured to:
determine an amount of nitrogen present in the third or fourth effluent and in at least one effluent to be extracted selected from the first effluent, the effluent from the at least one first electro-oxidation treatment reaction zone and the effluent from the at least one non-aerated biological treatment reaction zone of the first wastewater treatment unit,
then
determine a quantity of the at least one effluent to be extracted is determined in order to achieve a limit nitrogen content in the third or fourth effluent and control the at least one fluid displacement device to extract said quantity of the at least one effluent to be extracted and to mix it with the third or fourth effluent, and/or
determine a quantity of the effluent from the at least one first electro-oxidation treatment reaction zone to be sent to a non-aerated biological treatment reaction zone of the first treatment unit, this quantity corresponding to a nitrate and/or nitrite content required for non-aerated biological treatment to eliminate carbonaceous matter, and control the at least one fluid displacement device to send said quantity of this effluent to said non-aerated biological treatment reaction zone of the first wastewater treatment unit.
